(19) United States
(12) Patent Application Publication
(10) Pub. No.: US 2009/0111306 A1
(43) Pub. Date: Apr. 30, 2009

(54) ELECTRICAL CONNECTOR

(75) Inventors: Chih-Kuo Chou, Taipei City (TW); Po-An Lin, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: COMPAL ELECTRONICS, INC., Taipei City (TW)

(21) Appl. No.: 11/930,154

(22) Filed: Oct. 31, 2007

(51) Int. Cl. H01R 13/648

(52) U.S. Cl. 439/282; 439/607

(57) ABSTRACT

An electrical connector, suitable for being mounted on a circuit board, comprising an insulating housing, a plurality of terminals, and a shielding cover is provided. The insulating housing includes a plurality of terminal channels, inside which a plurality of terminals are disposed individually and electrically connected with the circuit board, wherein at least one of the terminals has a ground portion extending to the outside of the insulating housing. The shielding cover covers the insulating housing and has at least one elastic portion contacting tightly with the ground portion.

### BACKGROUND OF THE INVENTION

1. Field of the Invention

The present invention generally relates to an electronic element, in particular, to an electrical connector.

2. Description of Related Art

The development of semiconductor technology has soared in the past few decades, which dramatically decreased the size of portable electronic devices and increased the capacity exponentially. As the portable electronic devices became more powerful and versatile, the electronic elements composing the electronic devices, such as integrated circuits (ICs) and electrical connectors, also grew more complex, which made the electronic elements vulnerable to electromagnetic interference (EMI) and electrostatic discharge (ESD), hence raised the significance of electromagnetic shielding.

Therefore, new techniques has been developed and employed in order to advance the electromagnetic shielding ability of shielding covers. A conventional way to shield an electrical connector from EMI and ESD is to cover the electrical connector with a metal cover. For example, an EMI shielding mechanism disclosed in U.S. Pat. No. 6,540,556 utilizes a grounded metal cover to provide electromagnetic shielding for electrical connectors.

### SUMMARY OF THE INVENTION

Accordingly, the present invention is directed to an electrical connector having good electromagnetic shielding ability.

The present invention further provides an electrical assembly using the electrical connector and thus has higher reliability.

The present invention provides an electrical connector, suitable for being mounted on a circuit board, comprising an insulating housing, a plurality of terminals, and a shielding cover. There are a plurality of terminal channels in the insulating housing and a plurality of terminals are disposed individually and electrically connected with the circuit board, wherein at least one of the terminals has a ground portion extending to the outside of the insulating housing. The shielding cover covers the insulating housing and has at least one elastic portion contacting tightly with the ground portion.

According to an embodiment of the present invention, the terminal having the ground portion is electrically connected with a ground of the circuit board.

According to an embodiment of the present invention, each of the terminals has at least one mounting portion soldered to the circuit board.

According to an embodiment of the present invention, the shielding cover has at least a fixing portion soldered to the circuit board.

According to an embodiment of the present invention, the shielding cover is strip-shaped and has two fixing portions at both ends thereof, and the fixing portions are fastened to the circuit board.

According to an embodiment of the present invention, the material of the shielding cover includes metal.

According to an embodiment of the present invention, the elastic portion is clip-shaped.

According to an embodiment of the present invention, the elastic portion is bar-shaped.

According to an embodiment of the present invention, the elastic portion is ring-shaped.

The present invention further provides an electrical assembly comprising a circuit board and an electrical connector mounted on the circuit board. The electrical connector comprises an insulating housing, a plurality of terminals, and a shielding cover. There are a plurality of terminal channels in the insulating housing and a plurality of terminals are disposed individually and electrically connected with the circuit board, wherein at least one of the terminals has a ground portion extending to the outside of the insulating housing. The shielding cover covers the insulating housing and has at least one elastic portion contacting tightly with the ground portion.

According to an embodiment of the present invention, the terminal having the ground portion is electrically connected with a ground of the circuit board.

According to an embodiment of the present invention, each of the terminals has at least a mounting portion soldered to the circuit board.

According to an embodiment of the present invention, the shielding cover has at least a fixing portion soldered to the circuit board.

According to an embodiment of the present invention, the shielding cover is strip-shaped and has two fixing portions at both ends thereof, and the fixing portions are fastened to the circuit board.

According to an embodiment of the present invention, the material of the shielding cover includes metal.

According to an embodiment of the present invention, the elastic portion is clip-shaped.

According to an embodiment of the present invention, the elastic portion is bar-shaped.

According to an embodiment of the present invention, the elastic portion is ring-shaped.

As described above, the shielding cover is in contact with the ground portion of the terminal and the terminal with the ground portion is connected to a ground of the circuit board. That is to say, not only the fixing portions, the terminals having ground portions also ground the shielding cover, which provides more conductive path between the shielding cover and the ground and hence provide good electromagnetic shielding for the other terminals. Therefore, the reliability of the electrical connector is raised.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an electrical assembly according to an embodiment of the present invention.

FIG. 2 illustrates the insulating housing and the terminals of the electrical assembly in FIG. 1.

FIG. 3 illustrates one of the terminals having ground portions in FIG. 2.

FIG. 4 illustrates the shielding cover of the electrical connector in FIG. 2.

FIG. 5 illustrates an electrical connector according to another embodiment of the present invention.

FIG. 6 illustrates an electrical connector according to yet another embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

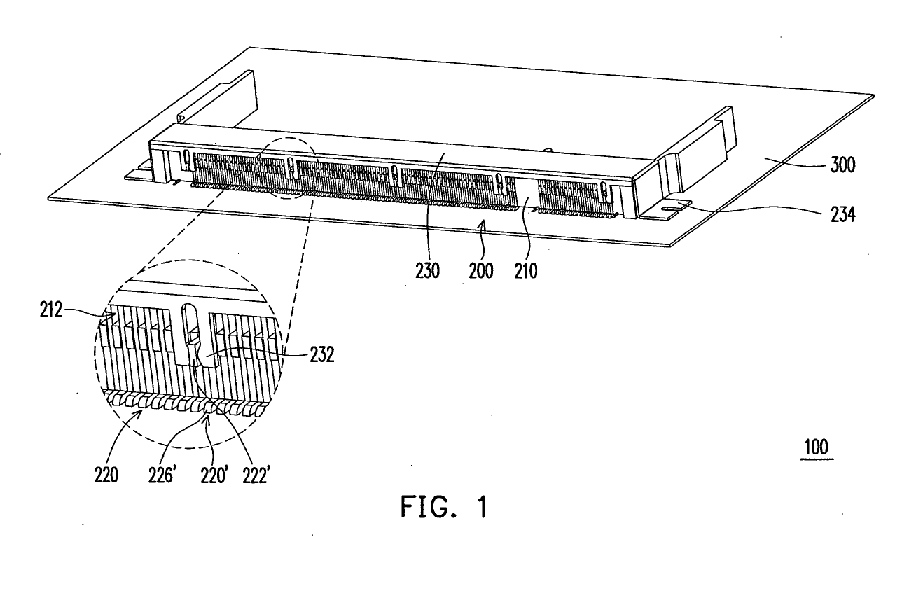

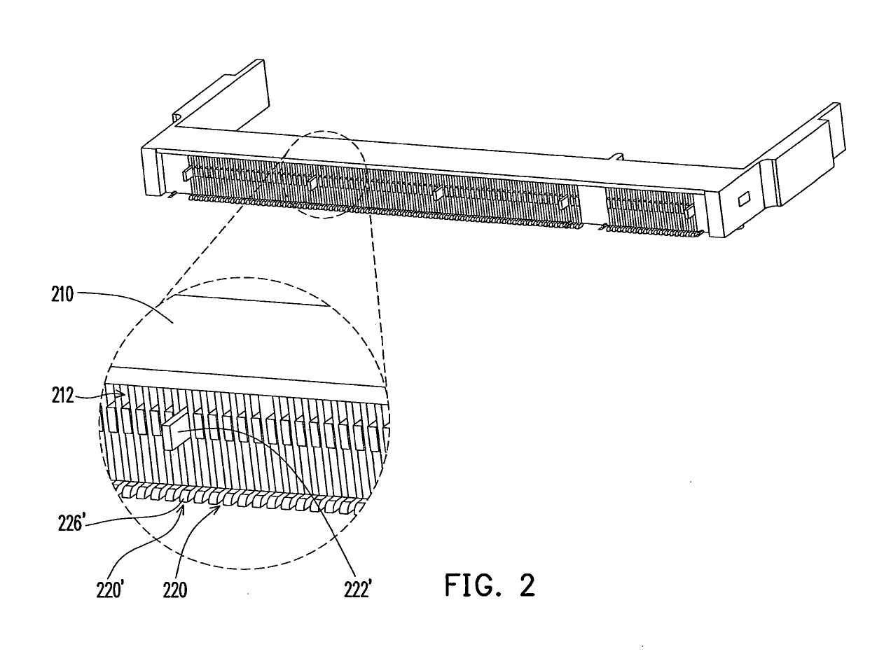

FIG. 1 illustrates an electrical assembly according to an embodiment of the present invention. Referring to FIG. 1, the electrical assembly 100 includes an electrical connector 200 and a circuit board 300, on which the electrical connector 200 is mounted. In the present embodiment, the electrical assembly 100 may be a part of a notebook computer, the circuit board 300 may be the motherboard of the notebook computer, and the electrical connector 200 may be a random access memory slot of the notebook computer. FIG. 2 illustrates the insulating housing and the terminals of the electrical assembly in FIG. 1. Referring to FIG. 1 and FIG. 2, the electrical connector 200 has an insulating housing 210 with a plurality of terminal channels 212, a plurality of terminals 220, each of which is disposed inside one of the terminal channels 212 and electrically connected with the circuit board 100, and a shielding cover 230, which may be made from metal, covering the insulating housing 210.

Moreover, there are a plurality of terminal 220′ among the terminals 220, each of which has a ground portion 222′ extending to the outside of the insulating housing 210 and may be electrically connected with a ground of the circuit board 300, where the shielding cover 230 has a plurality of elastic portions 232, each of which tightly contacts with one of the ground portion 222′ and thus grounds the shielding cover 230.

Since the elastic portions 232 of the shielding cover 230 is in contact with the ground portion 222′ of the terminals 220′, the shielding cover 230 is grounded by the electrical contact between the ground portion 222′ and the terminals 220′. To paraphrase, more conductive path between the shielding cover 230 and the ground of the circuit board 300 are utilized and thus improve the electromagnetic shielding capability of the electrical connector 200.

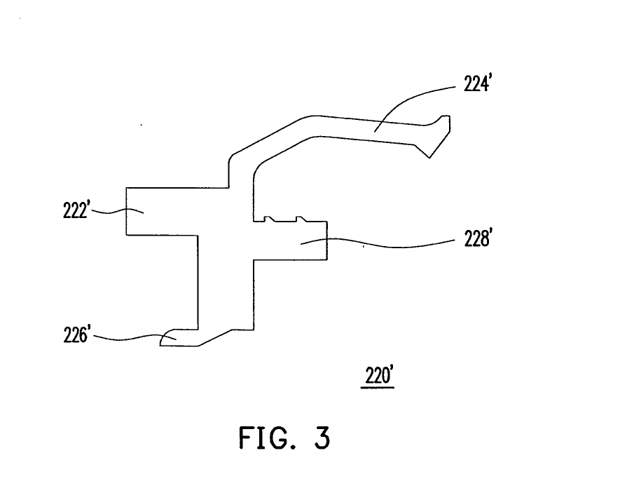

FIG. 3 illustrates one of the terminals having ground portions in FIG. 2. Referring to FIG. 3, besides the grounding portion 222′, each of the terminals may further have a contacting portion 224′, a mounting portion 226′ and a locking portion 228′, where the contacting portions 224′ may contact with the gold fingers of random access memory modules inserted into the electrical connector 200, the mounting portions 226′ may be soldered on the circuit board 300 to fix the terminals 220 thereon, and the locking portions 228 fastened on the insulating housing 210 and thus fasten the terminal 220 on the insulating housing 210.

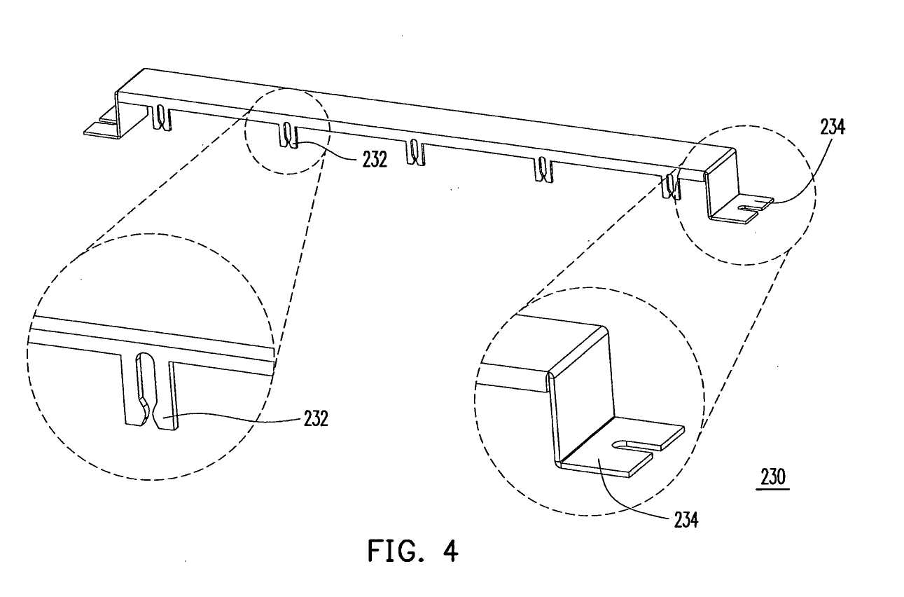

FIG. 4 illustrates the shielding cover of the electrical connector in FIG. 2. Referring to FIG. 1 and FIG. 4, the shielding cover 230 may further have a plurality of fixing portions 234, which may be at both ends of the shielding cover 230, and may be fastened to the circuit board 300 by means of, for example, soldering or screw. It is to be noticed that despite clip-shaped elastic portions 232 of the shielding cover 230 are revealed in the figures in order to demonstrate the present invention, however, elastic portions of other shapes are also applicable.

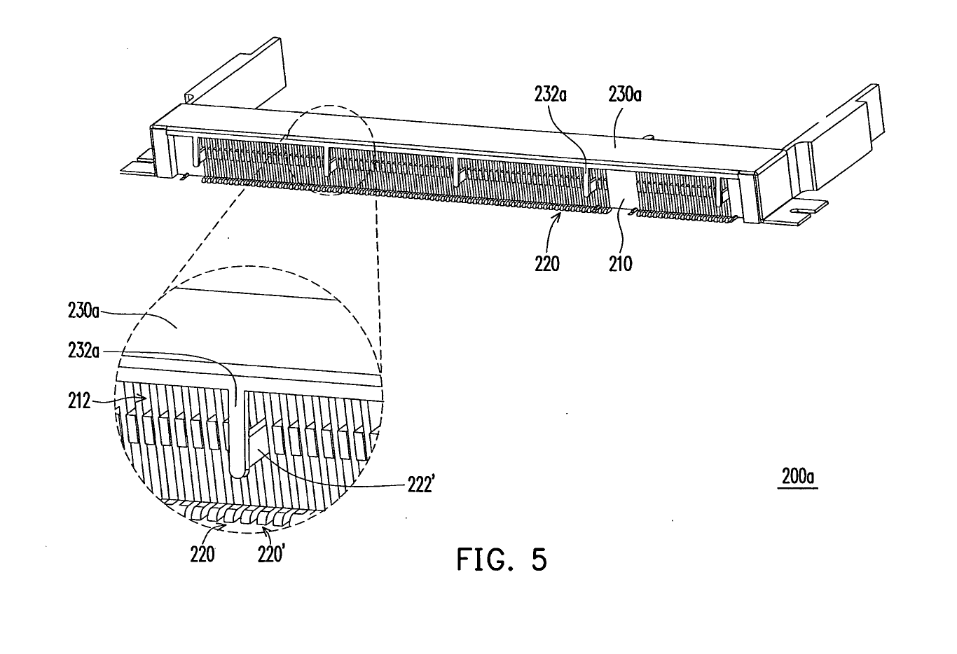

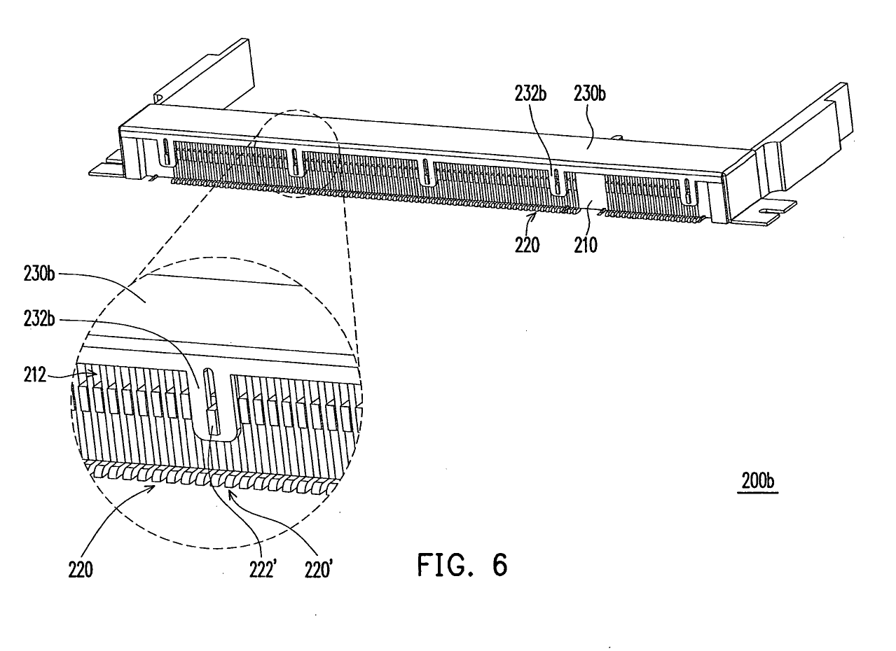

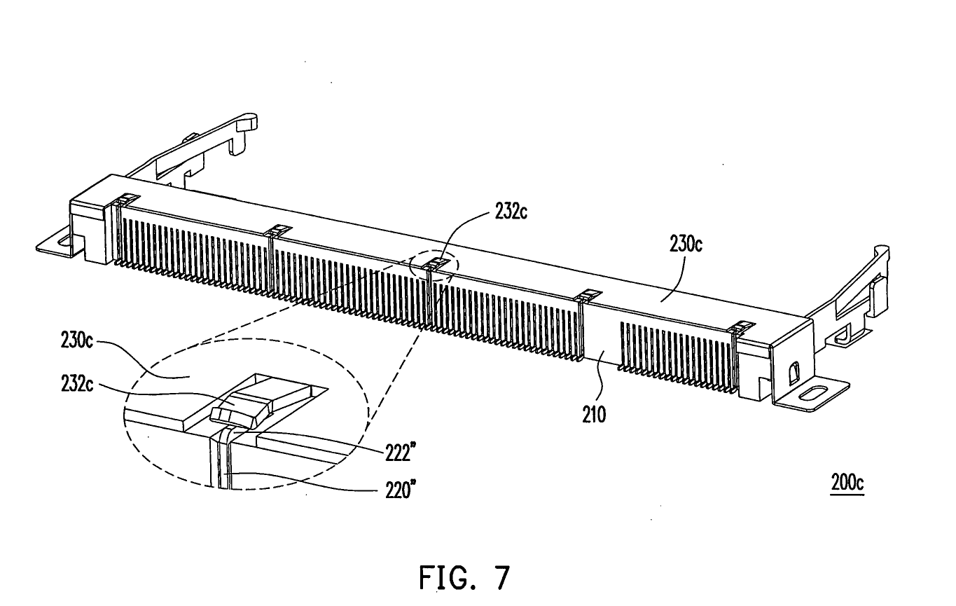

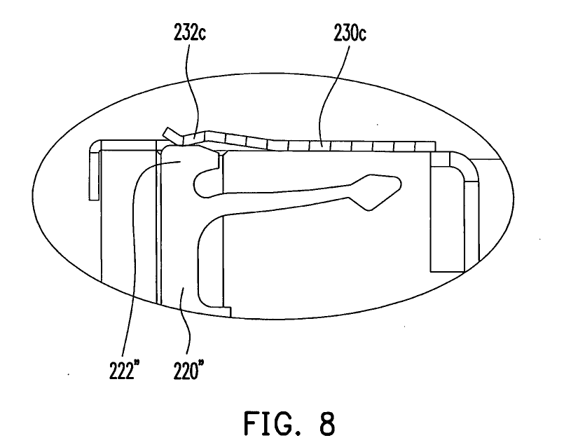

FIG. 5 illustrates an electrical connector according to another embodiment of the present invention, and FIG. 6 illustrates an electrical connector according to yet another embodiment of the present invention. Referring to FIG. 5 and FIG. 6, the elastic portions 232a of the shielding cover 230a of the electrical connector 200a are bar-shaped and the elastic portions 232b of the shielding cover 230b of the electrical connector 200b are ring shaped, respectively.

It is worth noting that although a plurality of terminals with ground portions are illustrated in the figures for the sake of clarifying the present invention, however, other quantities of terminals are also applicable, for example, applying only one terminal with a ground portion is also sufficient. Likewise, it is also sufficient to utilize only one fixing portion of the shielding cover.

In summary, the shielding cover is grounded via the electrical contact between the elastic portions of the shielding cover and the ground portions of the terminals, and thus provides electromagnetic shielding and therefore improves the reliability of the electrical assembly. Moreover, the terminals with the ground portions provide the shielding cover with a ground connection of the circuit board other than the fixing portions, which provides more conductive path between the ground and the shielding cover and therefore further enhances the electromagnetic shielding capability of the shielding cover.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electrical connector, suitable for being mounted on a circuit board, comprising:
an insulating housing, including a plurality of terminal channels;
a plurality of terminals, disposed inside the terminal channels individually and electrically connected with the circuit board, wherein at least one of the terminals has a ground portion extending to the outside of the insulating housing; and
a shielding cover, covering the insulating housing and having at least one elastic portion contacting with the ground portion.

2. The electrical connector according to claim 1, wherein the terminal having the ground portion is electrically connected with a ground of the circuit board.

3. The electrical connector according to claim 1, wherein each of the terminals has at least one mounting portion soldered to the circuit board.

4. The electrical connector according to claim 1, wherein the shielding cover has at least one fixing portion soldered to the circuit board.

5. The electrical connector according to claim 1, wherein the shielding cover is contacted with the circuit board.

6. The electrical connector according to claim 1, wherein the shielding cover is strip-shaped and has two fixing portions at both ends thereof, and the fixing portions are fastened to the circuit board.

7. The electrical connector according to claim 1, wherein the elastic portion is tightly contacted with the ground portion.

8. The electrical connector according to claim 1, wherein the material of the shielding cover includes metal.

9. The electrical connector according to claim 1, wherein the elastic portion is clip-shaped.

10. The electrical connector according to claim 1, wherein the elastic portion is bar-shaped.

11. The electrical connector according to claim 1, wherein the elastic portion is ring-shaped.

12. An electrical assembly, comprising:
a circuit board; and
an electrical connector mounted on a circuit board and comprising:
an insulating housing, including a plurality of terminal channels;
a plurality of terminals, disposed inside the terminal channels individually and electrically connected with the circuit board, wherein at least one of the terminals has a ground portion extending to the outside of the insulating housing; and
a shielding cover, covering the insulating housing and having at least one elastic portion contacting with the ground portion.

13. The electrical assembly according to claim 12, wherein the terminal having the ground portion is electrically connected with a ground of the circuit board.

14. The electrical assembly according to claim 12, wherein each of the terminals has at least one mounting portion soldered to the circuit board.

15. The electrical assembly according to claim 12, wherein the shielding cover has at least one fixing portion soldered to the circuit board.

16. The electrical assembly according to claim 12, wherein the shielding cover is strip-shaped and has two fixing portions at both ends thereof, and the fixing portions are fastened to the circuit board.

17. The electrical assembly according to claim 12, wherein the material of the shielding cover includes metal.

18. The electrical assembly according to claim 12, wherein the elastic portion is clip-shaped.

19. The electrical assembly according to claim 12, wherein the elastic portion is bar-shaped.

20. The electrical assembly according to claim 12, wherein the elastic portion is ring-shaped.
